(19) United States
(12) Patent Application Publication
(10) Pub. No.: US 2003/0152244 A1
(43) Pub. Date: Aug. 14, 2003

(54) High comfort sound delivery system

(76) Inventors: David Q. Dobras, San Francisco, CA (US); Jon C. Taenzer, Los Altos, CA (US)

Correspondence Address: Henneman & Saunders, 714 W. Michigan Ave., Three Rivers, MI, 49093, US

(21) Appl. No.: 10/336,235

(22) Filed: Jan. 3, 2003

Related U.S. Application Data
(63) Continuation of application No. 10/041,771, filed on Jan. 7, 2002, now abandoned.

(51) Int. Cl. H04R 25/00

(52) U.S. Cl. 381/381

(57) ABSTRACT

A high comfort sound delivery system (10) for use with a personal communications device such as a telephone. The high comfort sound delivery system (10) has a behind the ear piece (12) for holding the device on or near an ear of the user, and a sound horn (14) to be positioned at or near the ear canal of the user. Sound is produced by a speaker (26) in a speaker enclosure portion (15) of the behind the ear piece (12) and is delivered to the sound horn (14) through a generally flexible connecting member (16). Rotational adjustment is provide to rotating the connecting member (16) in relation to a speaker tube connection projection (20) and/or a sound horn tube connection projection (46). A length adjustment is provided by moving an elongated portion (66) of the connecting member (16) of the sound horn tube connection projection (46). Alternate sound horn bodies (42a, 42b, 42c, 42d, 42e, 42f) provide addition rotational adjustment points.

### RELATED APPLICATIONS

This application is a continuation of copending U.S. patent application Ser. No. 10/041,771 filed on Jan. 7, 2002 by the same inventors, and which is incorporated herein by reference in its entirety.

### TECHNICAL FIELD

The present invention relates to the field of audio transducer earpiece devices, and more particularly to an earpiece for use with electronic communications devices. The predominant current usage of the present inventive high comfort sound delivery system is in conjunction with portable personal communications devices, such as cellular or cordless telephones, two way radios, and the like, wherein it is desirable to have an apparatus for delivering sound to the ear of the user in a manner which does not cause discomfort to the user even when used over extended periods of time.

### BACKGROUND ART

Personal two way communications devices are becoming ever more popular. The use of cellular telephones is becoming more and more a part of everyday life, and the use of cordless telephone devices continues to increase. Also, the introduction of family radio services two way radios into the market place has greatly increased the popularity and usage of two way radios.

It has long been known in the industry to use a headset device for producing sound from such devices such that the user can hear the sound while others thereabout cannot. Also, an advantage of headset devices in general is that ambient noises are somewhat blocked while the desired sound is projected generally directly into the ear canal of the user. Therefore, the user can hear the desired sound even over significant ambient noise.

A more recent development in the field has been earpiece devices. An earpiece performs the general functions of a headset while being less bulky and obtrusive. An earpiece is affixed generally on or in one ear of the user. A sound producing earpiece may be used in conjunction with a separate microphone or sound pick up device, or else a microphone may optionally be incorporated into the earpiece such that a single apparatus will both convert the audio voice signals from the user into an electrical signal and also covert electrical signals form an attached device into audio signals intended to be heard by the user.

Another development in the field has been to provide a flexible connection 10 between a main earpiece body and a portion of the earpiece which fits in or near the ear canal of the user. U.S. patent application Ser. No. 09/870,398 entitled PERSONAL COMMUNICATIONS EARPIECE, and assigned to the assignee of this present application, teaches an example of such an earpiece.

It has been known to construct an earpiece with a separate sound delivery means that places a small speaker in an enclosure at the opening of the ear canal and which connects the speaker to a behind the ear member with a flexible two conductor electrical cable. Also known in the art are earpieces which place a speaker inside a behind the ear member, and which funnel sound produced by the speaker through a small diameter tube with an open end of the tube in the user's ear canal. Both of these types of construction have proven effective and useful for their intended purposes. However, with the increased use of cellular telephones, and the like, many users wish to keep their earpiece on their ear for all or most of the working day. Such extended periods of usage make desirable an even more comfortable and adaptable type of earpiece.

U.S. Pat. No. 6,009,183 entitled AMBIDEXTROUS SOUND DELIVERY SYSTEM teaches a communication device sound delivery tube system which can be used in either ear. However, this patent teaches using a tube which is placed inside the ear canal. Many people find this to be a solution which is useful for short periods of time, but which may be uncomfortable, especially when used for extended periods of time.

Also known in the art is an earphone type device for use where it is important to keep conversations from being overheard by others. This device has a speaker apparatus which is clipped below the collar, and wherein sound is delivered through a long tube to the ear. The tube of this device is tipped with an earmold shaped end. The earmold is nearly totally occluding, so the sound is unnatural, and for comfort the earmold must be custom shaped for the individual user's ear which is not a good feature for a consumer product.

Prior art also includes hearing health devices, for use by hearing impaired persons, or the like, which provide sound delivery to the ear through a tube. Normally, unlike a communication only device, these products employ high acoustic gain and, therefore, require high occlusion to prevent feedback “squeal”. High occlusion is achieved through custom earmolds or nearly occluding foam tips on the ends of the tubes.

Also known in the art are headset devices where sound is delivered to the ear through a tube from a speaker at the chest.

To the inventors' knowledge, the above described types of earpieces represent the prior state of the art in earpiece comfort. It is believed that prior art devices, while being useful for their intended purposes, have not provided a solution wherein user comfort, sound quality, feedback prevention, and other desirable qualities are found without significant sacrifice of at least one of these qualities in favor of another.

### DISCLOSURE OF INVENTION

Accordingly, it is an object of the present invention to provide a communications earpiece which will be comfortable to wear, even for extended periods of time.

It is another object of the present invention to provide a communications earpiece which is adjustable to accommodate different wearers and preferences.

It is still another object of the present invention to provide a communications earpiece wherein a user can vary the amount of inclusion of the device into the ear canal.

It is yet another object of the present invention to provide a communications earpiece which is adaptable to either the left or the right ear of the user.

It is still another object of the present invention to provide a communications earpiece wherein a speaker is protected from damage.

It is yet another object of the present invention to provide a communications earpiece wherein problems with broken speaker wires are minimized.

It is still another object of the present invention to provide a communications earpiece which can accept a relatively large speaker, thereby improving sound quality and/or reliability.

It is yet another object of the present invention to provide a communications earpiece wherein that portion thereof which is supported in or near the ear canal is light in weight, thereby improving comfort and decreasing the likelihood that such portion will become dislodged and/or fall out of the ear.

Briefly, the current invention utilizes a sound horn enclosure at the ear canal. In the present invention there is no speaker within the sound horn enclosure. A speaker is located in a behind the ear member, and sound is delivered by a small tube from the speaker to the sound horn enclosure, and delivered by the sound horn enclosure to the ear canal of the user. The sound horn enclosure is thereby the termination of the tube that carries the sound from the speaker, and also is the sound interface to the ear canal of the user.

The objects and advantages of the present invention will be illustrated herein in view of the description of modes of carrying out the invention, and the industrial applicability thereof, as described herein and as illustrated in the several figures of the drawing. The objects and advantages listed herein are not an exhaustive list of all possible advantages of the invention. Moreover, it will be possible to practice the invention even where one or more of the intended objects and/or advantages might be absent or not required in the application.

Further, those skilled in the art will recognize that various embodiments of the present invention may achieve one or more, but not necessarily all, of the above described objects and advantages. Accordingly, the listed advantages are not essential elements of the present invention, and should not be construed as limitations.

### BRIEF DESCRIPTION OF THE DRAWINGS

FIG. 1 is a partially cut away, partially exploded perspective view of an example of a high comfort sound delivery system according to the present invention;

FIG. 2 is a partially exploded perspective view of the acoustic transfer apparatus of the example of FIG. 1;

FIG. 3 is a partially exploded side elevational view of the acoustic transfer apparatus of the example of FIGS. 1 and 2;

FIG. 4 is a rear perspective view of the acoustic transfer apparatus of the example of FIGS. 1, 2 and 3;

FIG. 5 is a cross sectional side elevational view of the connecting member of FIGS. 1, 2, 3 and 4;

FIG. 6 is partially cut away side view of the example of the sound horn of FIGS. 1, 2, 3 and 4;

FIG. 7 is a side elevational view of an alternative example of an inverse horn according to the present invention;

FIG. 8 is a side elevational view of an alternative example of a sound horn body according to the present invention;

FIG. 9 is a partially cut away top view of the example of FIG. 8;

FIG. 10 is a side elevational view of yet another alternative example of a sound horn body according to the present invention;

FIG. 11 is a partially cut away side elevational view of the example of FIG. 10;

FIG. 12 is a rear elevational view of the example of FIGS. 10 and 11;

FIG. 13 is a side elevational view of still another alternative example of a sound horn body according to the present invention;

FIG. 14 is a rear elevational view of the example of FIG. 13;

FIG. 15 is a rear elevational view of yet another alternative example of a sound horn body according to the present invention;

FIG. 16 is a rear elevational-view of still another alternative example of a sound horn body according to the present invention;

FIG. 17 is a perspective view of an alternative example of an acoustic transfer apparatus according to the present invention; and

FIG. 18 is a perspective view of yet another alternative example of an acoustic transfer apparatus according to the present invention.

### DETAILED DESCRIPTION OF THE INVENTION

The embodiments and variations of the invention described herein, and/or shown in the drawings, are presented by way of example only and are not limiting as to the scope of the invention. Unless otherwise specifically stated, individual aspects and components of the invention may be omitted or modified, or may have substituted therefore known equivalents, or as yet unknown substitutes such as may be developed in the future or such as may be found to be acceptable substitutes in the future. The invention may also be modified for a variety of applications while remaining within the spirit and scope of the claimed invention, since the range of potential applications is great, and since it is intended that the present invention be adaptable to many such variations.

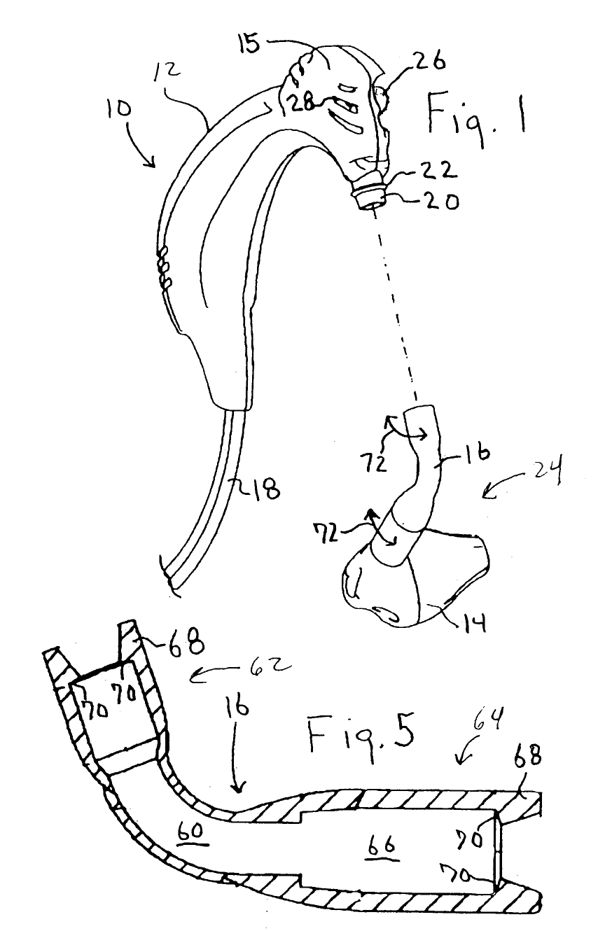

An example of a mode for carrying out the invention is a high comfort sound delivery system. The inventive high comfort sound delivery system is depicted in a partially cut away, partially exploded, perspective view in FIG. 1 and is designated therein by the general reference character 10. The high comfort sound delivery system 10 has a behind the ear piece 12, and a sound horn 14. The behind the ear piece 12 has a speaker enclosure portion 15. A connecting member 16 joins the behind the ear piece 12 to the sound horn 14. In the example of FIG. 1 an electrical wire 18 is provided to allow the high comfort sound delivery system 10 to communicate electrically with a telephone or other such device. However, it is within the scope of the invention that the high comfort sound delivery system 10 could readily be made a “wireless” device with no such external means for electrical connection. It should be noted that in many applications the behind the ear piece 12 will have a microphone therein or attached thereto, to allow for two way communications. However, the present invention addresses the method and apparatus for providing sound to the ear of the user, and so a microphone or other such device is not specifically discussed herein.

It should be noted that there are many possible shapes and configurations which could be substituted for the behind the ear piece 12 illustrated in the example of FIG. 1. Indeed, it is within the scope of the invention that this portion of the invention could be embodied in a housing which goes over the ear, or which partially encircles the ear, or the like. In any event, according to the present invention the behind the ear piece 12, or equivalent, will include a portion for housing a speaker 26 or other such transducer for converting electrical energy to an acoustic signal. In the example of FIG. 1, the speaker enclosure portion is optionally provided with a plurality of ports 28 for the passage of air therethrough to allow for free movement of the speaker 26.

As can be seen in the view of FIG. 1, the behind the ear piece 12 has a speaker tube connection projection 20 with a retaining ring 22 thereon for connection to an acoustic transfer apparatus 24. These will be discussed in greater detail hereinafter.

FIG. 2 is a partially exploded perspective view of the acoustic transfer apparatus 24 of the example of FIG. 1, FIG. 3 is a partially exploded side elevational view of the acoustic transfer apparatus 24 of FIG. 1, and FIG. 4 is a rear perspective view of the acoustic transfer apparatus 24 of FIG. 1. The acoustic transfer apparatus 24 has the connecting member 16 for connecting the behind the ear piece 12 (FIG. 1) to the sound horn 14. The connecting member 16 is hollow such that sound passes therethrough from the speaker 26 to the sound horn 14. As can be seen in the view of FIG. 2, the sound horn has a sound horn body 42 and an inverse horn 44. In the example of the invention shown, the sound horn body 42 is made of a generally rigid material, and the inverse horn 44 is made from a generally flexible material, since the inverse horn 44 is intended to be placed at or near the ear canal of the user, and the flexible material might be somewhat more comfortable than would a rigid material. However, it is not necessary to the invention that the types of materials used in the example of FIGS. 1 and 2 be used. In the view of FIG. 2 can also be seen a sound horn tube connection projection 46 extending from the sound horn body 42. The sound horn tube connection projection 46 is provided with a retaining ring 22.

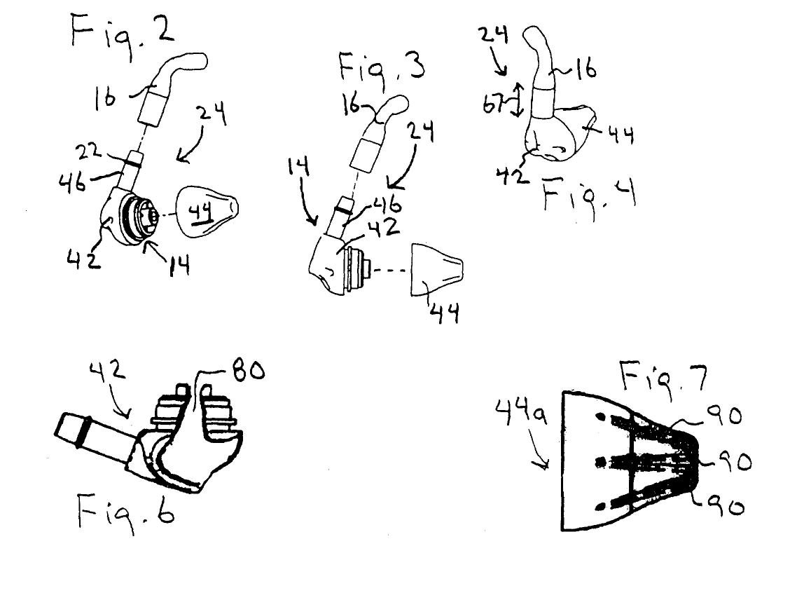

FIG. 5 is a cross sectional side elevational view of the connecting member 16 of FIGS. 1, 2, 3 and 4. In the view of FIG. 5 it can be seen that the connecting member 16 has a generally central preformed curved portion 60. The preformed curved portion 60 is curved, as appropriate for the particular design, such that the attached inverse horn 44 is positioned generally near the ear canal of the user and is pointed generally directly thereinto. The flexible curved portion 60 is, however, sufficiently flexible to allow for some adjustment of the position of the inverse horn 44 independent of other means of adjustment described herein. The connecting member 16 has a speaker enclosure attachment portion 62 at one end thereof and a sound horn attachment portion 64 at the other. The speaker enclosure attachment portion 62 and the sound horn attachment portion 64 are sufficiently flexible and are shaped such that they can be pushed over the speaker tube connection projection 20 (FIG. 1) and the sound horn tube connection projection 46, respectively.

In the embodiment shown and described in FIGS. 1 through 5, the sound horn attachment portion 64 has an elongated portion 66 into which is inserted the sound horn tube connection projection 46. As can be seen in the view of FIG. 3, the sound horn tube connection projection 46 is also somewhat elongated. Therefore, the overall effective length of the connecting member 16 can be adjusted by moving the sound horn tube connection projection 46 in or out within the sound horn attachment portion 64, as indicated by the bidirectional arrow 67 in FIG. 4.

Both the speaker enclosure attachment portion 62 and the sound horn attachment portion 64 have a connection lip 68 on the interior surface or the respective ends thereof, as can be seen in the view of FIG. 5. The connection lips are beveled, as shown in the view of FIG. 5, to allow the speaker enclosure attachment portion 62 and the sound horn attachment portion 64 to be pushed over the speaker tube connection projection 20 (FIG. 1) and the sound horn tube connection projection 46, respectively, and the retaining rings 22 thereof. The speaker enclosure attachment portion 62 and the sound horn attachment portion 64 also each have a retaining ridge 70 on the interior surface thereof. The retaining ridges 70 will engage the respective retaining rings 22 of the speaker tube connection projection 20 (FIG. 1) and the sound horn tube connection projection 46 to prevent the connecting member 16 from inadvertently being pulled away from the behind the ear piece 12 (FIG. 1) or the sound horn 14 (FIG. 1).

It should be noted that the connecting member 16 can be rotated about the longitudinal axis of the speaker tube connection projection 20 and/or the sound horn tube connection projection 46, as indicated by rotational arrows 72 in FIG. 1, thereby providing additional means for adjustment of position of the sound horn 14 (FIG. 1). Indeed, one or both of these can be rotated a combined total of approximately one half turn to switch the configuration of the apparatus from that appropriate for use with the user's left ear to that appropriate for use with the user's right ear, or vice versa.

FIG. 6 is partially cut away side view of the example of the sound horn body 42 of FIGS. 2, 3 and 4. In the view of FIG. 6 it can be seen that the sound horn body 42 is partially hollow to form a sound passage 80 therethrough such that sound coming through the connecting member 16 (FIG. 3) can pass through the sound passage 80 of the sound horn body 42 and into the inverse horn 44.

FIG. 7 is a side elevational view of an alternative example of an inverse horn 44a. As can be seen in the view of FIG. 7, the alternate inverse horn 44a has a plurality of flutes 90 distributed about the distal end thereof. The flutes 90 are intended to allow passage of air between the interior of the ear canal of the user and the outside thereof. Generally, it will not be intended that either the inverse horn 44 (FIG. 3) or the alternate inverse horn 44a entirely occlude the ear canal of the user. The flutes 90 will assist in preventing such occlusion, even if the alternate inverse horn 44a is pushed against, or even slightly into, the ear canal. It should be noted that the inverse horn 44 of FIG. 3, or any equivalent parts which are described herein or which might be substituted therefor, could optionally be provided with the flutes 90 as illustrated in FIG. 7.

Yet another aspect of the invention is that the sound horn body 42, or equivalent, can optionally be provided with a pivot apparatus such that it can pivot in relation to the connecting member 16. FIG. 8 is a side elevational view of an alternate example of a sound horn body 42a which provides such capability. As can be seen in the view of FIG. 8, the alternate sound horn body 42a has a rotational mechanism 100 which allows the alternate sound horn body 42a to rotate about a pivot pin 102 as indicated to rotational arrow 104. FIG. 9 is-a partially cut away top view of a relevant portion of the example of FIG. 8. In the view of FIG. 9 it can be seen that the rotational mechanism 100 has a first half 108 and a second half 110 which are free to rotate in relation to each other about the pivot pin 102. An air path 112 from the sound horn tube connection projection 46 into the alternate sound horn body 42a is provided by air passage slots 114 in the first half 108 and the second half 110. An O ring 116 generally prevents the escape of air (and sound) from within the rotational mechanism 110.

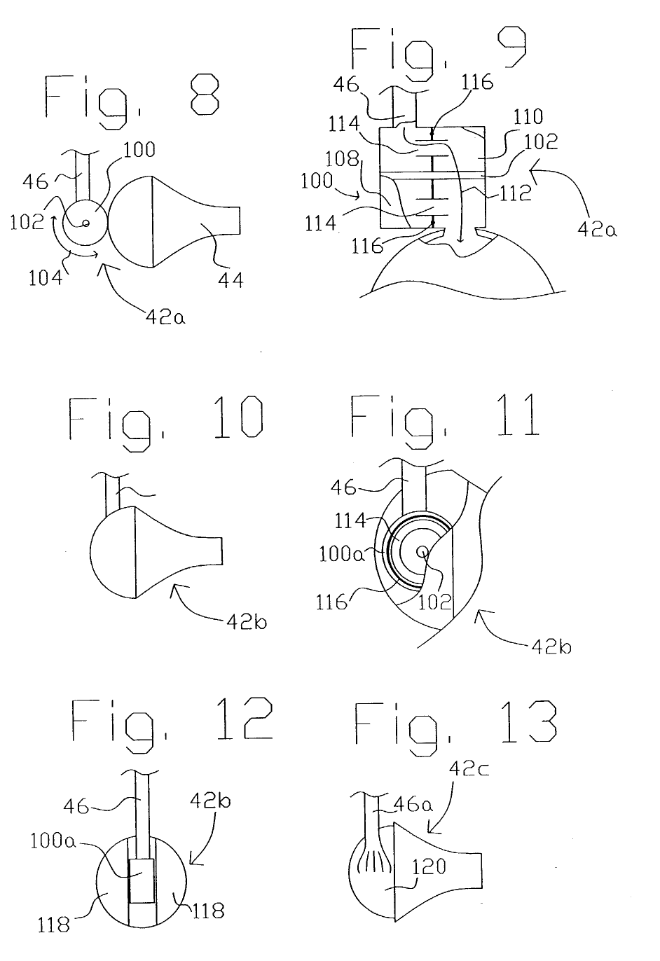

FIG. 10 is a side elevational view of yet another alternate example of a sound horn body 42b. In the view of FIG. 10 it can be seen that no rotational mechanism is visible from this view of the alternate sound horn body 42b. FIG. 11 is a partially cut away side elevational view of a relevant portion of the alternate sound horn body 42b. Visible in the view of FIG. 11 is an alternate rotational mechanism 100a having the O ring 116, pivot pin 102 and air passage slot 114 as described previously herein. FIG. 12 is a rear elevational view of the alternate sound horn body 42b. From the view of FIG. 12 it can be seen that the alternate rotational mechanism 100a is located between two lobes 118 of the alternate sound horn body 42b. In this embodiment of the invention sound passes from the sound horn tube connection projection 46 through the alternate sound horn body 42b and out through the air passage slot 114 (FIG. 11) into the lobes 118, in a manner similar to that described previously herein in relation to the first described embodiment of the rotational mechanism 100.

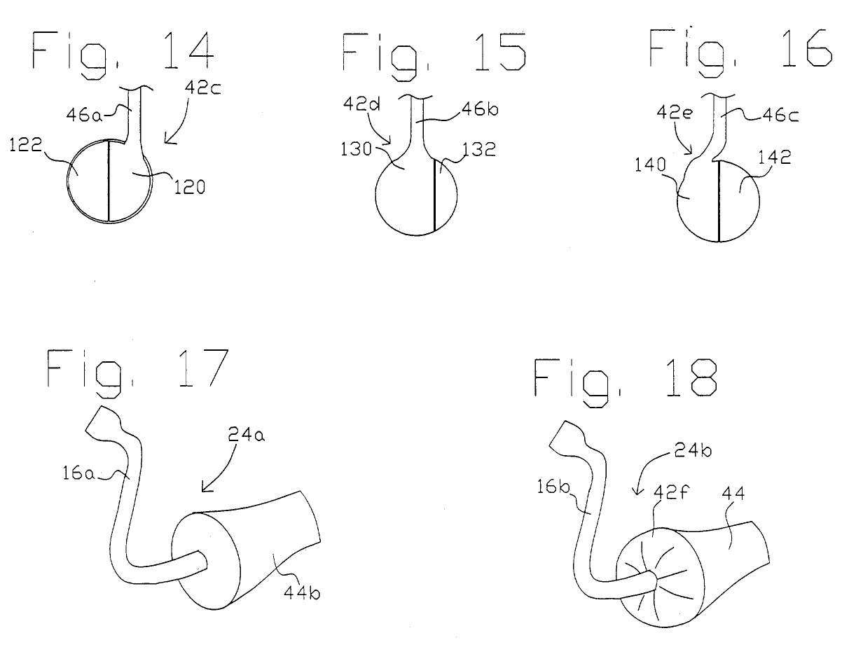

FIG. 13 is a side elevational view of still another alternative example of a sound horn body 42c. As can be seen in the view of FIG. 13, an alternate sound horn tube connection projection 46a is integral with a first half 120 of the alternate sound horn body 42a. The alternate sound horn tube connection projection 46a is molded as an integral part of the first half 120 of the alternate sound horn body 42a in the embodiment shown, although it is within the scope of the invention that it be formed separately and affixed by some other means such as glue, press fitting, or the like. FIG. 14 is a rear elevational view of the example of alternate sound horn body 42c. In the view of FIG. 14 it can be seen that a second half 122 of the alternate sound horn body 42c is separate from the first half 120. In this embodiment of the invention, the inverse horn 44 is affixed to the second half 122 of the alternate sound horn body 42c. The first half 120 and the second half are free to rotate in relation to each other in like manner to the first half 108 and the second half 110 of the rotational mechanism 100 previously described herein. Note that the base of sound horn 42c is flared to slide freely over the rounded portion of first half 120. Indeed, this embodiment differs from that of the alternate sound horn body 42a described in relation to FIGS. 8 and 9 primarily in that, in this presently described embodiment, the halves 120 and 122 of the alternate sound horn body 42c function generally in like manner to the two halves 108 and 110 of the previously described rotational mechanism 100. Within the alternate sound horn body 42c (but not visible in the view of FIG. 14) are the O ring 116, air passage slot 114, and pivot pin 102 as previously described herein in relation to FIGS. 8 and 9.

FIG. 15 is a rear elevational view of yet another alternative example of a sound horn body 42d. The alternate sound horn body 42d differs from the previously described alternate sound horn body 42c (FIG. 14) generally only in that a first half 130 and a second half 132 thereof are of unequal size, such that an alternate sound horn tube connection projection 46b can be centrally located on the alternate sound horn body 42d.

FIG. 16 is a rear elevational view of yet another alternative example of a sound horn body 42e. The alternate sound horn body 42e differs from the previously described alternate sound horn body 42c (FIG. 14) generally only in that an alternate sound horn tube connection projection 46c is formed so as to allow the projection thereof to be generally centrally located on the alternate sound horn body 42e while the first half 140 and the second half 142 of the alternate sound horn body 42e remain generally equal in size.

FIG. 17 is a perspective view of an alternative example of an acoustic transfer apparatus 24a. The alternate acoustic transfer apparatus is but one of many possible examples of a device which incorporates most, but not all, of the present inventive features. In the alternate acoustic transfer apparatus, an alternate connecting member 16a is affixed directly to an alternate inverse horn 44b.

FIG. 18 is a perspective view of yet another alternative example of an acoustic transfer apparatus 24b. In the example of FIG. 18, an alternate connecting member 16b is connected directly to an alternate sound horn body 42f which has affixed thereto an inverse horn 44 not unlike those previously described herein.

Various modifications may be made to the invention without altering its value or scope. For example, the exact shapes of the various parts of the invention which are shown and described herein are at least partially somewhat arbitrary and intended for visual appeal. Significant cosmetic changes could be made in the devices without altering their inventive purpose or function. The earbud shaped inverse horn 44, and alternatives, could be formed in a great many alternative shapes and configurations without violating the essence of the invention. For example, inverse horn 44 could be molded as a single unit with the sound horn body 42. The materials described herein could also be varied. Additionally, as discussed briefly previously herein, one or more of the several adjustments discussed herein could be eliminated without changing the value or scope of the invention. Since so many points of adjustment are provided, functionality of the inventive devices would not be substantially altered, in at least some applications, if some or all of the rotational or length adjustments were eliminated and/or if some of the flexibility of the flexible components described herein were reduced or eliminated.

Yet another obvious modification would be to vary the connection points and/or manner of the connecting member 16. For example, the embodiment of the invention described herein in relation to FIG. 1 shows rotational connections on both ends of the connecting member 16. It would also be within the intended scope of the invention to have the connecting member 16 enter the behind the ear piece 12 and be terminated internally thereto.

All of the above are only some of the examples of available embodiments of the present invention. Those skilled in the art will readily observe that numerous other modifications and alterations may be made without departing from the spirit and scope of the invention. Accordingly, the disclosure herein is not intended as limiting and the appended claims are to be interpreted as encompassing the entire scope of the invention.

Industrial Applicability

The inventive high comfort sound delivery system 10 and equivalents are intended to be widely used in conjunction with a variety of personal communications devices such as cellular and cordless telephones and two way radio devices. Particularly in the case of cellular telephones, it is known that having a hands free type of apparatus provides a significant safety function, particularly when the user is driving an automobile or otherwise engaged in some other activity. The fact that the design of the present inventive high comfort sound delivery system 10 allows the inverse horn 44 to be readily positioned such that it does not completely block or occlude the ear canal of the user enhances the safety and convenience of the invention, in that the user's hearing is not significantly impaired. According to the present invention, the inverse horn 44 is positioned at, but not necessarily in, the ear canal.

Additionally, the fact that the high comfort sound delivery system 10 is comfortable and convenient to wear will increase the likelihood that the devices will be used, as opposed to holding a cellular telephone, or the like, in one hand of the user. The design and function of the present invention will help to prevent feedback, in that sound is directed into the ear canal of the user, while providing the comfort and safety of allowing the reception of ambient sound by the user.

Since the high comfort sound delivery system 10 and equivalents of the present invention may be readily produced and integrated with existing cellular telephones and other such devices, and since the advantages as described herein are provided, it is expected that it will be readily accepted in the industry. For these and other reasons, it is expected that the utility and industrial applicability of the invention will be both significant in scope and long-lasting in duration.

We claim:

1. A communications earpiece comprising:
an earpiece portion;
a transducer housed generally within the ear piece portion;
a sound horn; and
a generally tubular connection member for channeling sound from the ear piece portion to the sound horn.

2. The communications earpiece of claim 1, wherein:
the transducer is a speaker.

3. The communications earpiece of claim 1, wherein:
the transducer is housed within a speaker enclosure portion of the earpiece portion.

4. The communications earpiece of claim 1, wherein:
the earpiece portion has at least one port for admitting ambient air therethrough.

5. The communications earpiece of claim 1, wherein:
the sound horn has a sound horn body and a distal inverted horn.

6. The communications earpiece of claim 5, wherein:
the sound horn body and the inverted horn are integral.

7. The communications earpiece of claim 5, wherein:
the sound horn body has a rotational mechanism for allowing the sound horn body to pivot in relation to a connection projection on the sound horn body.

8. The communications earpiece of claim 5, wherein:
the sound horn body has a rotational mechanism for allowing the sound horn body to pivot in relation to the connection member.

9. The communications earpiece of claim 1, wherein:
the sound horn body has a connection projection which is inserted into the connection member.

10. The communications earpiece of claim 9, wherein:
the connection projection can be turned within the connection member such that the sound horn body rotates in relation to the connection member.

11. The communications earpiece of claim 9, wherein:
the connection projection can be moved at least partially into and out of the connection to move the sound horn body linearly in relation to the connection member.

12. The communications earpiece of claim 1, wherein:
the connecting member is generally flexible.

13. The communications earpiece of claim 1, wherein:
the connecting member is preformed in a generally curved shape.

14. The communications earpiece of claim 1, wherein:
the earpiece portion has a connection projection which is inserted into the connection member.

15. A sound reproduction apparatus, comprising:
a behind-the-ear speaker housing;
an earbud;
a sound tube for transmitting sound from the speaker housing to the earbud.

16. The sound reproduction apparatus of claim 15, wherein:
the sound tube is rotatable in relation to the speaker housing.

17. The sound reproduction apparatus of claim 16, wherein:
the sound tube is rotatable in relation to the earbud.

18. The sound reproduction apparatus of claim 15, wherein:
the sound tube is preformed to hold the earbud in position in relation to the speaker housing.

19. The sound reproduction apparatus of claim 15, wherein:
the sound tube is generally flexible.

20. The sound reproduction apparatus of claim 15, wherein:
the earbud can be selectively moved at least partially into and out of the sound tube.
